(19) United States
(12) Patent Application Publication
(10) Pub. No.: US 2012/0260476 A1
(43) Pub. Date: Oct. 18, 2012

(54) ECOLOGICALLY FRIENDLY, FURNITURE QUALITY CASKET

(76) Inventors: Bruce Burnside, Spring Lake, MI (US); Ken Fox, Monroe, MI (US); Tim Spurlock, Carey, OH (US)

(21) Appl. No.: 13/452,888

(22) Filed: Apr. 22, 2012

Related U.S. Application Data
(63) Continuation-in-part of application No. 13/210,760, filed on Aug. 16, 2011.
(60) Provisional application No. 61/401,635, filed on Aug. 16, 2010.

(51) Int. Cl. A61G 17/007; A61G 17/00

(52) U.S. Cl. 27/16

(57) ABSTRACT

A casket is provided that is made entirely from naturally occurring materials. The casket includes a box having a bottom and a plurality of side walls. A hinge assembly is provided including a first member that is secured to a side wall of the box and a second member that is pivotally supported on the first member by a dowel pin. A lid is secured to the second member of the hinge assembly for pivotal movement between a closed position and an opened position.

### CROSS-REFERENCE TO RELATED APPLICATIONS

This application is a continuation-in-part of co-pending U.S. application Ser. No. 13/210,760 filed on Aug. 16, 2011, which claimed the benefit of U.S. Provisional Application No. 61/401,635 filed Aug. 16, 2010. The disclosures of both of these applications are incorporated herein by reference.

### BACKGROUND OF THE INVENTION

This invention relates in general to caskets, such as can be used in the display and burial of a body. In particular, this invention relates to an improved structure for a casket that is made from naturally occurring and ecologically friendly materials, yet still provides a furniture quality appearance.

Caskets are well known structures that are used in the display and burial of a body. A typical casket defines a box-like structure that includes a bottom, a front wall, a rear wall, two end walls, and at least one lid pivotally supported thereon for movement between an opened position and a closed position. Caskets are generally made from a wide variety of materials that do not occur naturally in the environment, including plastics, fiberglass, metals, and other materials. However, many of these materials are not ecologically friendly and, in some instances, can be harmful for the environment when disposed in the ground for extended periods of time. Thus, it would be desirable to provide a casket that is made entirely from naturally occurring and ecologically friendly materials, yet still provides a furniture quality appearance.

### SUMMARY OF THE INVENTION

This invention relates to an improved structure for a casket that is made entirely from naturally occurring materials, yet still provides a furniture quality appearance. The casket includes a box having a bottom and a plurality of side walls. A hinge assembly is provided including a first member that is secured to a side wall of the box and a second member that is pivotally supported on the first member by a dowel pin. A lid is secured to the second member of the hinge assembly for pivotal movement between a closed position and an opened position.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a casket having a lid in an opened position in accordance with this invention.

FIG. 2 is an enlarged, partially sectioned side view of a portion of the casket shown in FIG. 1 illustrating a hinge assembly when the lid is in a closed position.

FIG. 3 is a partially sectioned side view similar to FIG. 2 illustrating the hinge assembly when the lid is in an opened position.

FIG. 4 is a perspective view of the casket shown in FIG. 1 illustrating a locking mechanism.

FIG. 5 is a front view of the locking mechanism shown in FIG. 4 with a decorative cover removed.

FIG. 6 is a rear view of an internal portion of the casket shown in FIG. 4 illustrating the locking mechanism in a locked position.

FIG. 7 is a rear view of an internal portion of the casket shown in FIG. 4 illustrating the locking mechanism after being moved from the locked position to an unlocked position.

FIG. 8 is a sectional side view of an alternative locking mechanism for use with the casket shown in FIG. 1 in accordance with this invention.

FIG. 9 is a perspective view of an adjustable bed for use in the casket shown in FIG. 1.

FIG. 10 is a perspective view of an internal portion of the casket shown in FIG. 1 illustrating a bed pillow system being inserted into a groove that is provided in a cap of the casket.

FIG. 11 is a sectional side view of the bed pillow system inserted into the groove of the cap as shown in FIG. 10.

FIG. 12 is a perspective view of an internal portion of the casket shown in FIG. 1 illustrating a support arm holding the lid in an opened and locked position.

FIG. 13 is a side view of the support arm shown in FIG. 12 when the lid is in a closed position.

FIG. 14 is a side view of the support arm shown in FIG. 12 when the lid is in the opened and locked position.

FIG. 15 is a side view of a second embodiment of a hinge assembly for use with the casket shown in FIG. 1 in accordance with this invention.

FIG. 16 is a side view of the hinge assembly shown in FIG. 15 when the lid is in a partially opened position.

FIG. 17 is a side view of the hinge assembly shown in FIG. 15 when the lid is in an opened and locked position.

FIG. 18 is a side view of the hinge assembly shown in FIG. 15 when the lid is in an opened and unlocked position.

FIG. 19 is a perspective rear view of a third embodiment of a hinge assembly for use with the casket shown in FIG. 1 in accordance with this invention.

FIG. 20 is a side view of the hinge assembly shown in FIG. 19 when the lid is in the closed position.

FIG. 21 is a side view of the hinge assembly shown in FIG. 19 when the lid is in a partially opened position.

FIG. 22 is a side view of the hinge assembly shown in FIG. 19 when the lid is in a fully opened position.

FIG. 23 is a partially exploded, front perspective view of a fourth embodiment of a hinge assembly for use with the casket shown in FIG. 1 in accordance with this invention.

FIG. 24 is a side view of the hinge assembly shown in FIG. 23 when the lid is in a closed position.

FIG. 25 is a side view of the hinge assembly shown in FIG. 23 when the lid is in an opened position.

### DETAILED DESCRIPTION OF THE PREFERRED EMBODIMENTS

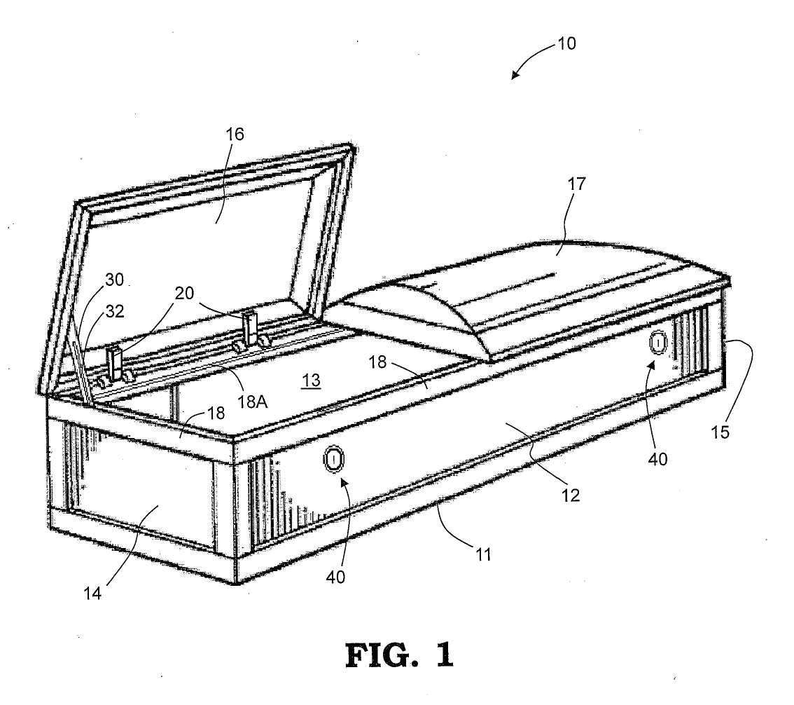

Referring now to the drawings, there is illustrated in FIG. 1 a casket, indicated generally at 10, in accordance with this invention. The casket 10 can be used in the display and burial of a body (not shown). As will be explained below, the casket 10 is made entirely from naturally occurring materials that are ecologically friendly and safe for the environment, such as wood for example. Although the casket 10 will be described for use in the display and burial of a body, it should be appreciated that the casket 10 can be used in any desired environment and for any desired purpose.

The illustrated casket 10 defines a box-like structure that includes a bottom 11, a front wall 12, a rear wall 13, and a pair of end walls 14 and 15. In other non-illustrated embodiments, the casket 10 can have any number or configuration of walls (i.e. a six sided coffin, for example). The casket 10 may also include any number of lids, such as a pair of lids 16 and 17, which are pivotally supported on the rear wall 13, as shown. The lids 16 and 17 can be moved between an opened position for display of a body and a closed position for burial of the body. The lids 16 and 17 can be any shape or have any structural features for a desired application.

The illustrated casket also includes a cap 18 that is secured along upper edges of the respective walls 12, 13, 14, and 15, although such is not required. As shown, the cap 18 is configured to extend around a perimeter of the casket 10 that is defined by the walls 12, 13, 14, and 15. The illustrated cap 18 defines a T-shape configuration with the walls 12, 13, 14, and 15 that adds structural strength to the casket 10 for reducing or minimizing deflection and bowing thereof. As such, the cap 18 can have any dimensions based on the strength required due to various wood densities and expected weight loads. The cap 18 also provides a flat, stable base for the lids 16 and 17 to be seated onto the walls 12, 13, 14, and 15. The cap 18 also adds depth to the appearance of the walls 12, 13, 14, and 15 and allows movable components of the casket 10 to be concealed from view, as will be further explained below.

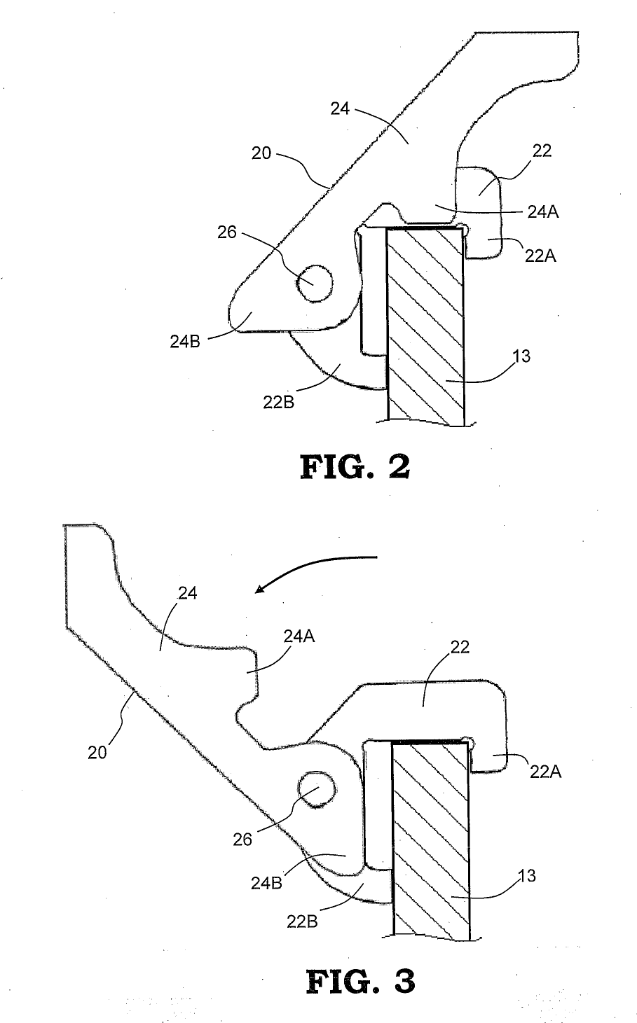

The illustrated casket 10 also includes a plurality of hinge assemblies 20 that pivotally support the lids 16 and 17 on the rear wall 13. The illustrated hinge assemblies 20 are similar to each other, although such is not required. Therefore, only one hinge assembly 20 will be further described with reference to FIGS. 2 and 3. The illustrated hinge assembly 20 is pivotal between a first or closed position, as shown in FIG. 2, and a second or opened position, as shown in FIG. 3. It should be appreciated, however, that the hinge assembly 20 can pivotally support the lids 16 and 17 in any desired position.

The hinge assembly 20 includes at least one first or base member 22 that is secured to the rear wall 13 of the casket 10. The hinge assembly 20 further includes a second or pivotal member 24 that is secured to the lid 16 (not shown). The pivotal member 24 is pivotally mounted to the base member 22 by a dowel pin 26 or the like to facilitate pivotal movement of the lid 16 relative to the casket 10. In the illustrated embodiment shown in FIG. 1, the pivotal member 24 is secured between a pair of the base members 22. However, it should be appreciated that the hinge assembly 20 can be configured in any manner.

As shown in FIGS. 2 and 3, the base member 22 includes a front leg 22A and a rear leg 22B that straddle the rear wall 13 for firmly supporting the base member 22 thereto. For example, the front leg 22A extends downwardly along an inner surface of the rear wall 13 and includes a surface that is configured to be seated against the inner surface of the rear wall 13. Similarly, the rear leg 22B extends downwardly along an outer surface of the rear wall 13 and includes a surface that is configured to be seated against the outer surface of the rear wall 13. As such, the base member 22 can be mounted over the cap 18 if so desired. The base member 22 can be secured to the rear wall 13 in any manner, including but not limited to a natural adhesive, wooden dowels, a tongue-and-groove connection, or any other means.

The illustrated pivotal member 24 is an elongated arm that radially extends outwardly from the base member 22. The pivotal arm 24 is configured to be attached to the lid 16 to facilitate pivotal movement thereof between the opened and closed positions. The pivotal arm 24 can be attached to the lid 16 in any manner, including but not limited to a natural adhesive, wooden dowels, a tongue-and-groove connection, or any other means.

The illustrated pivotal member 24 also includes a first shoulder 24A, although such is not required. The first shoulder 24A is configured to engage the upper edge of the rear wall 13 or the cap 18 when the lid 16 is in the fully closed position to prevent further pivotal movement thereof. As shown, the first shoulder 24A extends outwardly from an inner surface of the pivotal member 24 and is centrally located along a length thereof. The first shoulder 24A can be integrally formed with the pivotal member 24 or can be a separate component that is secured thereto if so desired, such as a pad member or a stopper.

The illustrated pivotal member 24 also includes a second shoulder 24B, although such is not required. The second shoulder 24B is configured to engage an outer surface of the rear wall 13 or other portion of the casket 10 when the lid 16 is in the fully opened position to prevent further pivotal movement of the lid 16. As shown, the second shoulder 24B extends from an end portion of the pivotal member 24B that is connected to the base member 22. It should be appreciated that the second shoulder 24B can be have any size or shape to allow the lid 16 to achieve a desired opened position. The second shoulder 24B can be integrally formed with the pivotal member 24 or can be a separate component that is secured thereto if so desired, such as a pad member or a stopper.

As briefly mentioned above, the dowel pin 26 pivotally attaches the pivotal member 24 to the base member 22. The dowel pin 26 can be a wooden, cylindrical member that is disposed within coaxially aligned apertures formed in each of the base member 22 and the pivotal member 24. The illustrated dowel pin 26 defines an axis of rotation that is spaced away from an outer surface of the rear wall 13 and spaced a vertical distance below a top edge of the rear wall 13. This configuration allows the lid 16 to fully pivot away from the rear wall 13 and achieve a fully opened position. It should be appreciated that the dimensions of the hinge assembly 20 and its various components can be modified to accommodate heavier or lighter load expectations and wood types.

Referring back to FIG. 1, a support arm 30 is pivotally connected to at least one of the lids 16 and 17 for supporting and locking the respective lids 16 and 17 in the opened position, although such is not required. As shown in FIGS. 12 through 14, an end of the support arm 30 is pivotally connected to an inner surface of the lid 16 by a support bracket 31 and a dowel pin 31A that extends through the support bracket 31 and the support arm 30. The illustrated support arm 30 is an elongated member that extends downwardly from the inner surface of the lid 16. The support arm 30 may optionally extend through a slot (not shown) formed in an upper surface of the cap 18. Thus, the support arm 30 is largely concealed within the interior of the casket 10. The support arm 30 provides a smooth, uninterrupted movement as the lid 16 is pivoted between the opened and closed positions.

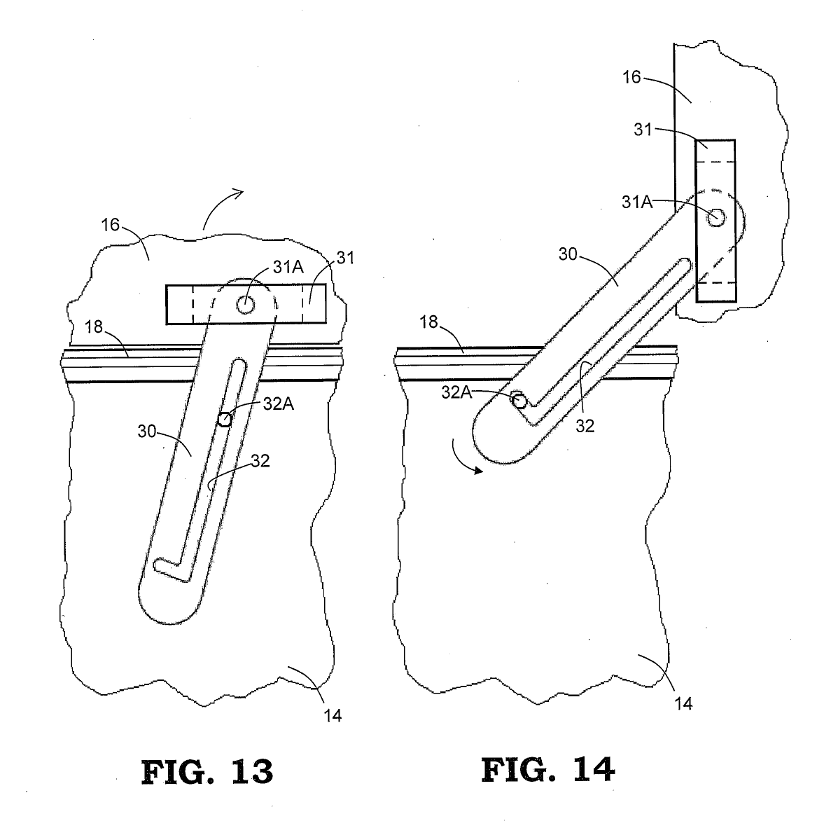

The illustrated support arm 30 defines a slot 32 that may extend along a length thereof. The slot 32 is configured to receive a guide pin 32A that is fixed to the inner surface of the end wall 14. The slot 32 provides a generally linear path that includes an L-shaped portion located near the pivotal end of the support arm 30. As the lid 16 is pivoted from the closed, as shown in FIG. 13, to the opened position, as shown in FIG. 14, the guide pin 32A travels along the slot 32. When the lid 16 reaches the fully opened position, the pivotal end of the support arm 30 automatically pivots downwardly under the influence of gravity to a locked position, as indicated by the direction arrow, such that the guide pin 32A becomes engaged within the L-shaped portion of the slot 32. This allows the lid 16 to be supported in the fully opened position and prevents the lid 16 from falling back to the closed position. To close the lid 16, the support arm 30 can be manually pivoted from the locked position so that the guide pin 32A is removed from the L-shaped portion of the slot 32. It should be appreciated that the support arm 30 and the slot 32 can have any size or shape for a desired application.

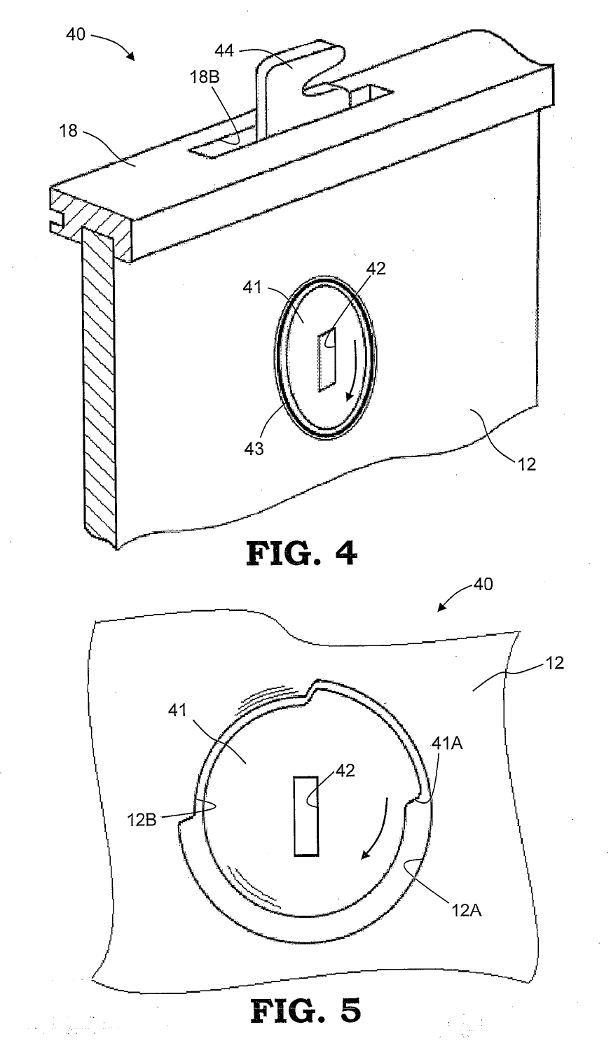

Referring back to FIG. 1, the illustrated casket 10 further includes a pair of locking mechanisms, indicated generally at 40, for respectively locking the lids 16 and 17 in the closed position. The pair of locking mechanisms 40 are similar to one another and, therefore, only one of the locking mechanisms 40 will be described with reference to FIGS. 4 through 7. As shown in FIG. 4, the locking mechanism 40 includes a rotatable member 41 that is supported for rotation within an aperture 12A (see FIG. 5) that extends through the front wall 12. The rotatable member 41 can define a key-hole 42 formed therein. A decorative trim piece 43 can be secured to an outer surface of the front wall 12 to conceal edges of the rotatable member 41 if so desired. A latch member 44 is pivotally connected at a first end thereof (not shown) to the rotatable member 41 and extends along an inner surface of the front wall 12 upwardly through a slot 18B formed in the cap 18. The locking mechanism 40 may, however, be provided on the end walls 14 and 15 if so desired.

As shown in FIG. 5, a front elevational view of the locking mechanism 40 is illustrated with the trim piece 43 removed. The illustrated front wall 12 includes an aperture 12A that extends therethrough. The front wall 12 may also define a ledge or shoulder 12B that radially extends inwardly toward a center of the aperture 12A, the purpose of which will be explained below. The rotatable member 41 is disposed within the aperture 12A of the front wall 12. The illustrated rotatable member 41 is annular in shape and may include a shoulder 41A that radially extends outwardly therefrom. The shoulder 12B of the front wall 12 and the shoulder 41A of the rotatable member 40 are configured to limit rotational movement of the rotatable member 41, such as to approximately one hundred eighty degrees for example.

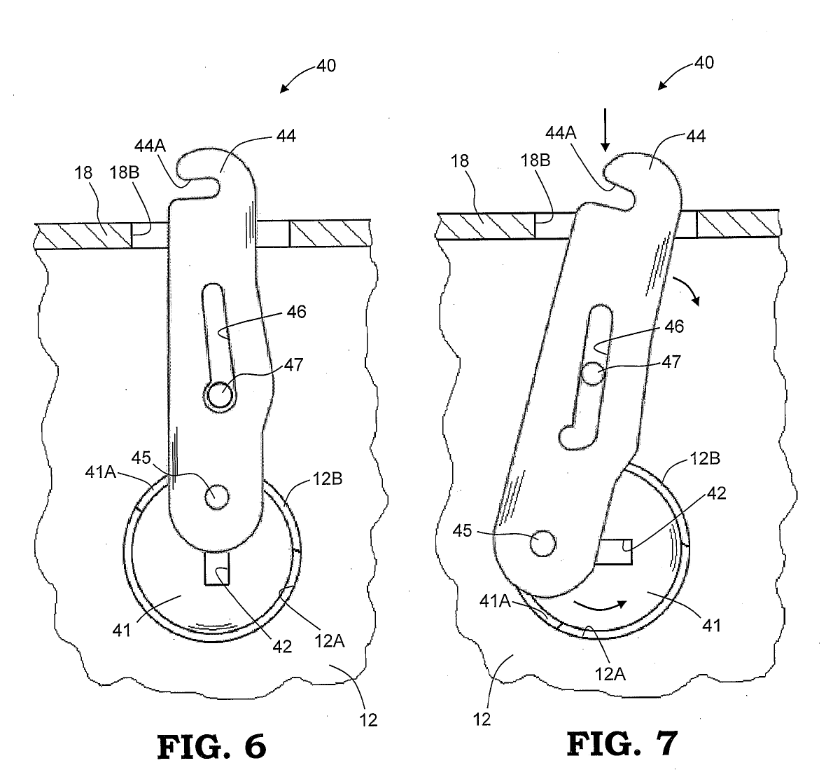

As shown in FIGS. 6 and 7, an internal view of the locking mechanism is provided. The illustrated latch member 44 is an elongated arm that is pivotally attached at a first end to the rotatable member 41. For example, the latch member 44 can be attached to the rotatable member 41 by a dowel pin 45 or the like. A second end of the latch member 44 defines a hook portion 44A that is configured to secure the lid 16 (not shown) in the closed position.

The illustrated latch member 44 also includes a slot 46 that extends along any intermediate length thereof. The slot 46 is configured to receive a guide pin 47 that is fixed to the front wall 12. For example, the guide pin 47 can be a wooden dowel pin having any dimensions. The slot 46 provides a generally linear path that includes an L-shaped portion located near the first end of the latch member 44. As the rotatable member 41 is rotated, the latch member 44 moves up and down as the guide pin 47 travels along the linear path of the slot 46. Further, the linear path of the illustrated slot 46 is angled relative to a center line of the latch member 44 to provide pivotal movement of the hook portion 44A, the purpose of which will be explained below.

When the locking mechanism 40 is in a first or locked position, as shown in FIG. 6, the latch member 44 extends upwardly through the slot 18B formed in the cap 18 and the lid 16 (not shown). When the locking mechanism 40 is rotated to a second or unlocked position, as shown in FIG. 7, the second end of the latch member 44 is pivoted as a result of the slot 36 and disengages from the lid 16. The latch member 44 is then retracted downwardly through the slot 18B in the cap 18 and is concealed within an interior region of the casket 10. The illustrated locking mechanism 40 need not be lubricated if desired, thereby eliminating or reducing the potential for stain contamination of interior liners or mating components.

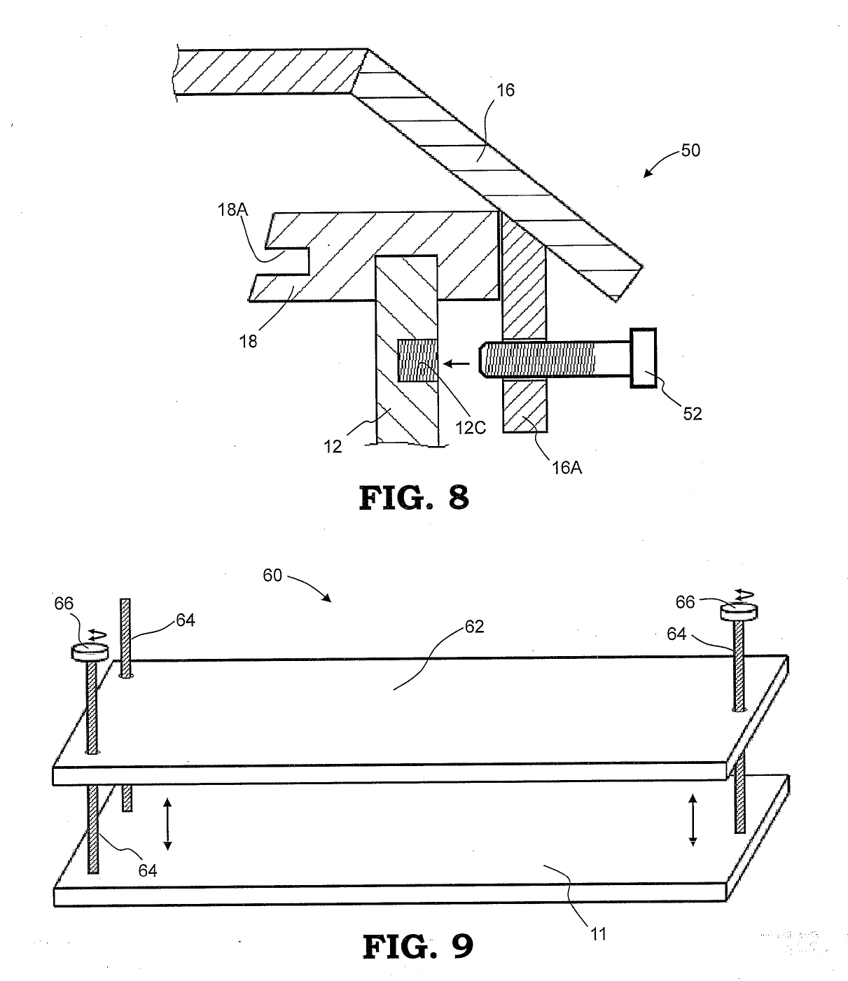

As shown in FIG. 8, there is illustrated an alternative embodiment of a locking mechanism, indicated generally at 50. The alternative locking mechanism 50 includes a locking pin 52 that extends through a portion of the lid 16 for engagement with the front wall 12. For example, the lid 16 may include a bracket 16A that extends downwardly therefrom along the front surface of the front wall 12. The illustrated bracket 16A includes an aperture extending therethrough. The locking pin 52 can be inserted through the aperture in the bracket 16A for engagement with the front wall 12.

As shown, the front wall 12 may include a recess 12C that extends into the front surface thereof. Thus, an end portion of the locking pin 52 can be received within the recess 12C to provide additional support to the locking mechanism 50. Alternatively, the locking pin 52 need not be received within a recess, but may otherwise be seated against or engage a lower surface of the cap 18. The locking pin 52 can be a wooden member having an externally threaded portion. The aperture formed in the bracket 16A and/or the recess 12C formed in the front wall 12 may have a corresponding internally threaded portion if so desired. It should be appreciated, however, that the locking mechanism 50 can be configured in any suitable manner.

Referring now to FIG. 9, there is illustrated an adjustable bed, indicated generally at 60, that can be disposed within an internal portion of the casket 10. The adjustable bed 60 enables a body (not shown) to be selectively positioned at a desired elevation relative to the bottom 11 of the casket 10. The illustrated adjustable bed 60 includes a generally flat, rectangular bed plate 62 having a plurality of legs 64 vertically extending therethrough. The legs 64 can be wooden members having an externally threaded portion. The legs 64 are vertically supported on the bottom 11 of the casket 10 and extend upwardly through internally threaded apertures in the bed plate 62. As such, the legs 64 form threaded connections with the apertures in the bed plate 62. A cap 66 or the like can be removably attached to an upper end of each of the legs 64 to facilitate rotation of the respective leg by hand. When the legs 64 are rotated, the bed plate 62 moves in axial direction relative to the legs 64. Thus, the bed plate 62 can be raised or lowered to a desired height relative to the bottom 11 of the casket 10 if so desired.

As shown, a pair of the legs 64 is respectively located near opposite corners of a first end of the bed plate 62 for supporting the upper region of a body. A single leg 64 can be centrally located near a second end of the bed plate 62 for supporting the lower region of a body. It should be appreciated, however, that any number or configuration of legs 64 can be used depending on expected loads and differing wood types.

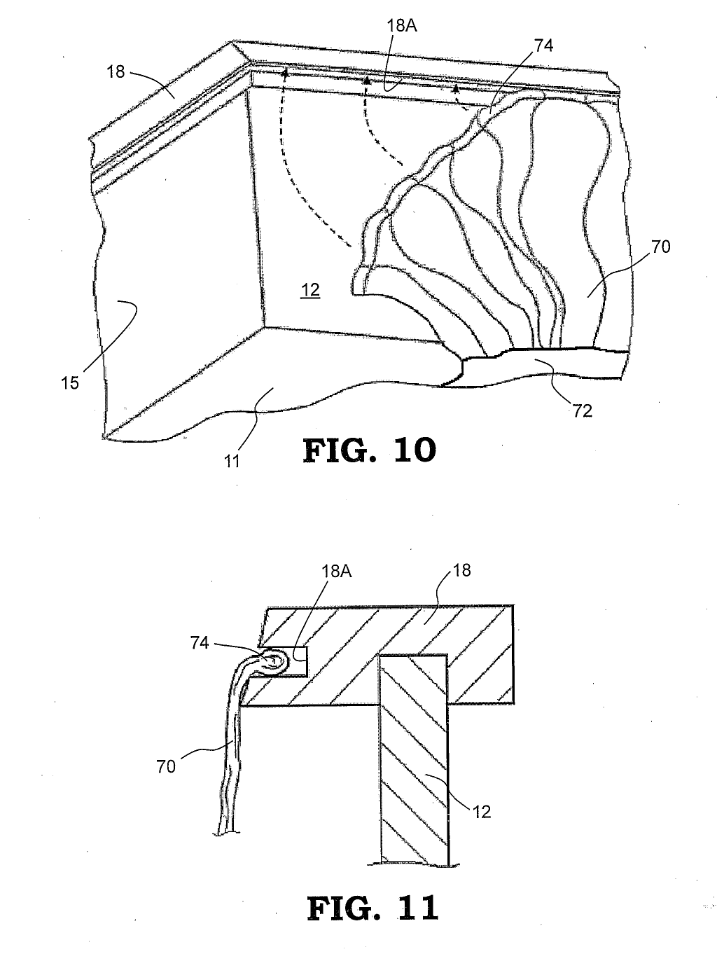

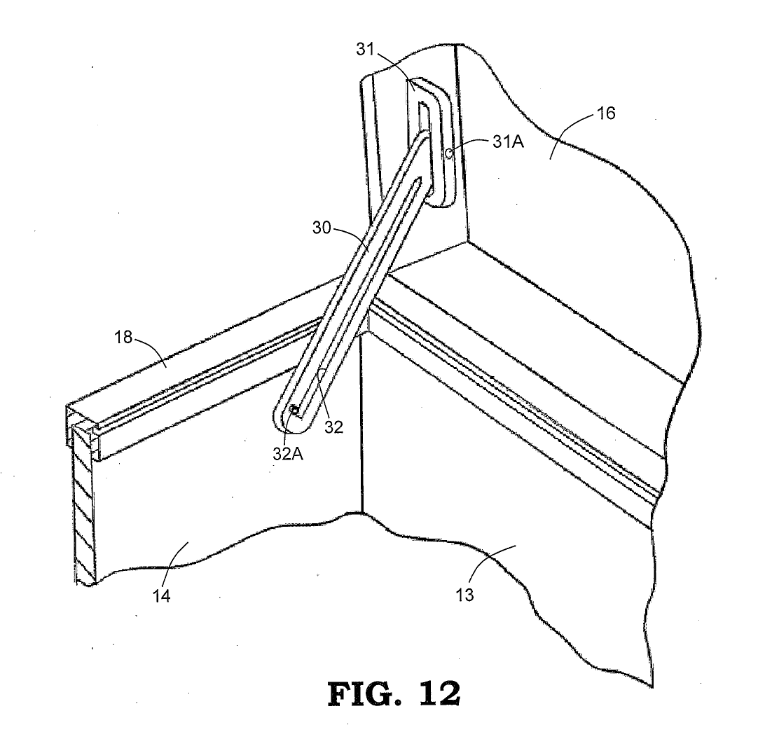

Referring now to FIGS. 10 and 11, the illustrated casket 10 also includes a bed pillow system having a skirt 70 and a bed pillow 72, although such is not required. The skirt 70 vertically extends along the inner surfaces of the walls 12, 13, 14, and 15, or any combination thereof. The skirt 70 can be made from any natural fabric that is ecologically friendly, such as cotton or silk for example.

The illustrated bed pillow 72 lies along an inner surface of the bottom 11. The bed pillow 72 can be stuffed with wood shavings or other naturally occurring materials to achieve an absorbent, soft bed without the use of plastic or synthetic liners. For example, the bed pillow 72 can have a first layer of cotton, a second layer of wood shavings, a third layer of cotton, and fourth layer of wood shavings or wool, and a fifth layer of cotton. The layers can be sewn together to form the bed pillow 72 with a top sheet of silk. The bed pillow 72 may, however, be made from any other natural materials as desired. It should be appreciated that the skirt 70 and the bed pillow 72 can be sewn together to form a single bed pillow system or may be used separately.

To secure the illustrated skirt 70 and bed pillow 72 within the casket 10, the inner surfaces of the cap 18 may include a groove 18A that extends around the inner perimeter of the casket 10. Further, an upper edge of the skirt 70 may be provided with a cord 74. The cord 74 can be tucked into the groove 18A such that the skirt 70 hangs downwardly from the cap 18. The cord 74 can be any natural material that is ecologically friendly, such as twine, yarn, or the like. Thus, the groove 18A allows the skirt 70 to be attached along an inner perimeter of the casket 10 without the use of fasteners. The fastening system described herein also allows for easy installation and removal of the skirt 70 and/or the bed pillow 72 should they get soiled, torn, or otherwise need to be partially removed to add hidden pillows (not shown). The groove 18A may have any dimensions for use with a desired skirt 70 and may include a raised lip (not shown) or other structural features to help retain the cord 74 therein. Further, the groove 18A need not be formed in the cap 18, but may otherwise be provided along the inner surfaces of the respective walls 12, 13, 14, and 15 if so desired.

It should be appreciated that the casket 10 may include any additional features, such as structural or aesthetic features. For example, the casket 10 can include hand rails, internal corner posts, external end posts, fittings, decorative trimming, drapery, or the like. Further, all of the structural features of the casket 10 (i.e. walls, lids, hinges, locking mechanisms, pins, dowels, supports, etc.) can be made from naturally occurring materials, including but not limited to various woods such as pine, oak, yew, mahogany, bamboo, willow, hard woods, or any other ecologically friendly materials.

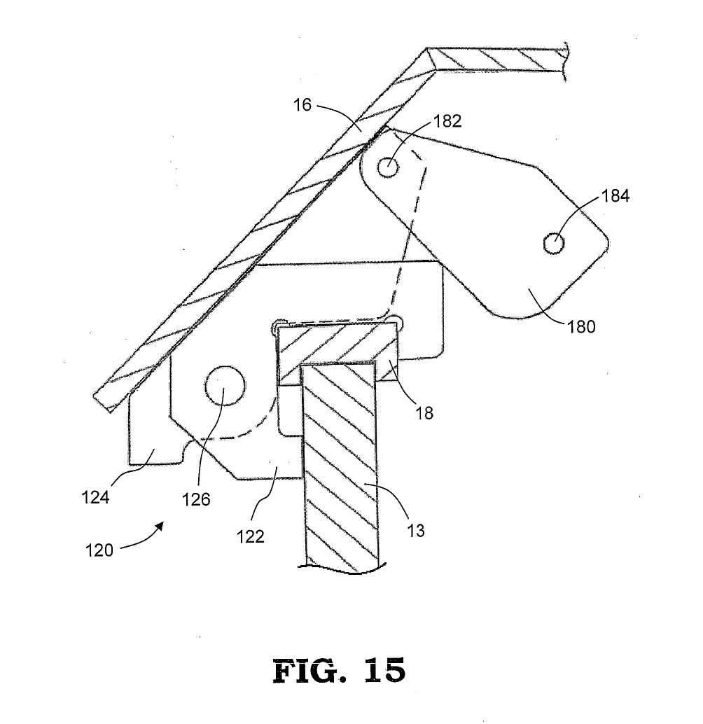

Referring now to FIGS. 15 through 18, there is illustrated a second embodiment of a hinge assembly, indicated generally at 120. The hinge assembly 120 may include any structural features as described and illustrated above in the first embodiment, although such is not required. Similar features have been numbered with common reference numerals but have been increased by 100 (e.g. 120, 122, 124, etc.). It should be appreciated that similar features are structured similarly, operate similarly, and/or have the same function unless otherwise indicated by the drawings or this specification.

For example, the hinge assembly 120 is configured to pivotally support the lid 16 on the rear wall 13 of the casket 10 as shown in FIG. 1. The illustrated hinge assembly 120 includes a first or base member 122 and a second or pivotal member 124. The base member 122 is secured to the rear wall 13 of the casket 10 using a natural adhesive, a dovetail connection, wooden pegs, or any other type of connection. The pivotal member 124 is movably supported on the base member 122 by a dowel pin 126. The dowel pin 126 extends through a set of coaxially aligned holes that are formed in both the base member 122 and the pivotal member 124. As such, the illustrated pivotal member 124 is supported adjacent to a side surface of the base member 122. It should be appreciated that the pivotal member 124 can be supported between a pair of base members 122. In turn, the lid 16 is secured to the pivotal member 124 using a natural adhesive, a dovetail connection, wooden pegs, or any other type of connection.

The illustrated hinge assembly 120 also includes a securing member 180 for locking the lid 16 in the opened position, as will be described below. The illustrated securing member 180 is pivotally supported on the pivotal member 124 by a second dowel pin 182 or the like. The illustrated securing member 180 is supported adjacent to the same surface of the pivotal member 124 that is adjacent to the base member 122. Thus, the securing member 180, or at least a portion thereof, is co-planar with the base member 122 and is configured to contact an edge thereof. For example, the securing member 180 contacts the base member 122 along their respective edges as the lid 16 is moved between the closed and opened positions, the purpose of which will be explained below.

The illustrated securing member 180 may also include a knob 184, although such is not required. The knob 184 can be any structure that extends outwardly from the securing member 180 to facilitate pivotal movement thereof. For example, the illustrated knob 184 is a cylindrical member extending from a side surface of the securing member 180. Alternatively, the knob 184 can have any desired shape or structural feature and may extend from any portion of the securing member 180, such as an edge thereof.

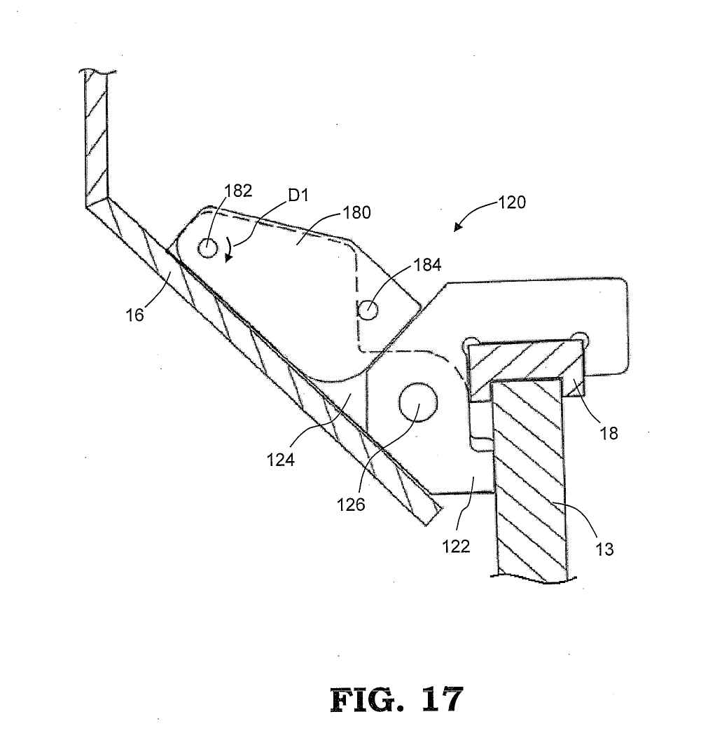

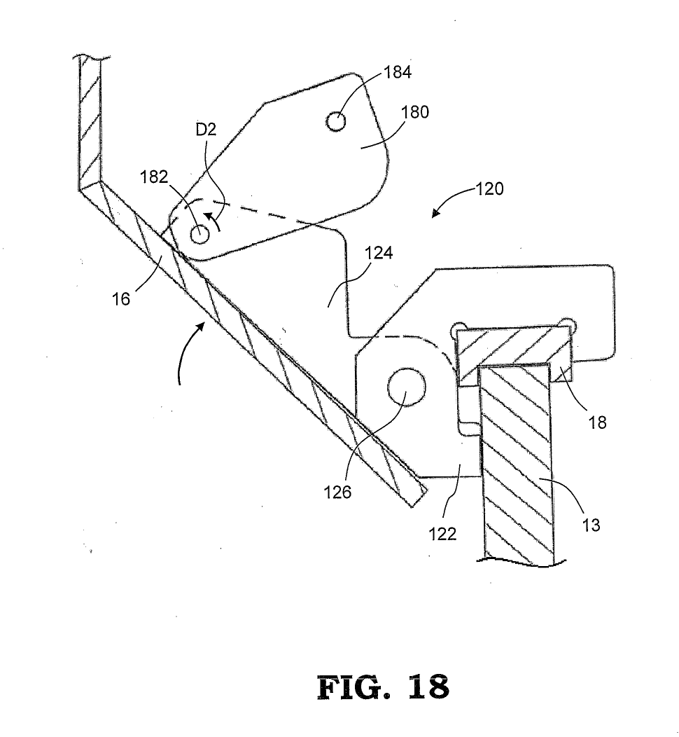

As briefly described above, the lid 16 is supported on the casket 10 for movement between a closed position, as shown in FIG. 15, and an opened position, as shown in FIGS. 17 and 18. In the closed position, the illustrated securing member 180 extends from the pivotal member 124 toward an internal portion of the casket 10. An edge of the securing member 180 rests in contact with a front, upper edge of the base member 122.

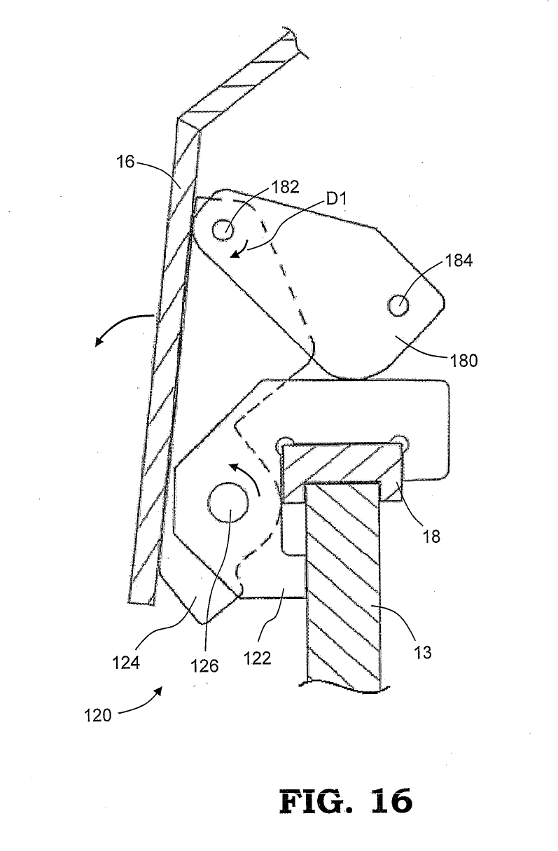

When the lid 16 is moved to a partially opened position, as shown in FIG. 16, the securing member 180 begins to pivot about the second dowel pin 182 toward an inner surface of the lid 16, as indicated by arrow D1. The securing member 180 can pivot automatically as a result of gravity or, alternatively, may be biased to pivot toward the lid 16 using a spring member (not shown) or the like. Thus, a lower edge of the securing member 180 rides along an upper edge of the base member 122 as the lid 16 is moved toward the opened position.

Once the lid 16 reaches the opened position, as shown in FIG. 17, the securing member 180 and the base member 122 include corresponding edges that come into contact with one another. In effect, the securing member 180 automatically wedges against the base member 122, which is fixed relative to the rear wall 13 of the casket 10. When the corresponding edges are in contact with one another, the securing member 180 is in a locked position and prevents the lid 16 from closing due to movement of the casket 10 or incidental contact with the lid 16.

To close the lid 16, the securing member 180 can be initially moved from the locked position, as indicated by direction arrow D2 in FIG. 18. For example, the knob 184 can be used to manually pivot the securing member 180 about the second pivot pin 182 until the securing member 180 is no longer in contact with the base member 122. Then, the lid 16 can be moved from the opened position back to the closed position. The steps described above for opening and closing the lid 16 of the casket 10 can be repeated any number of times.

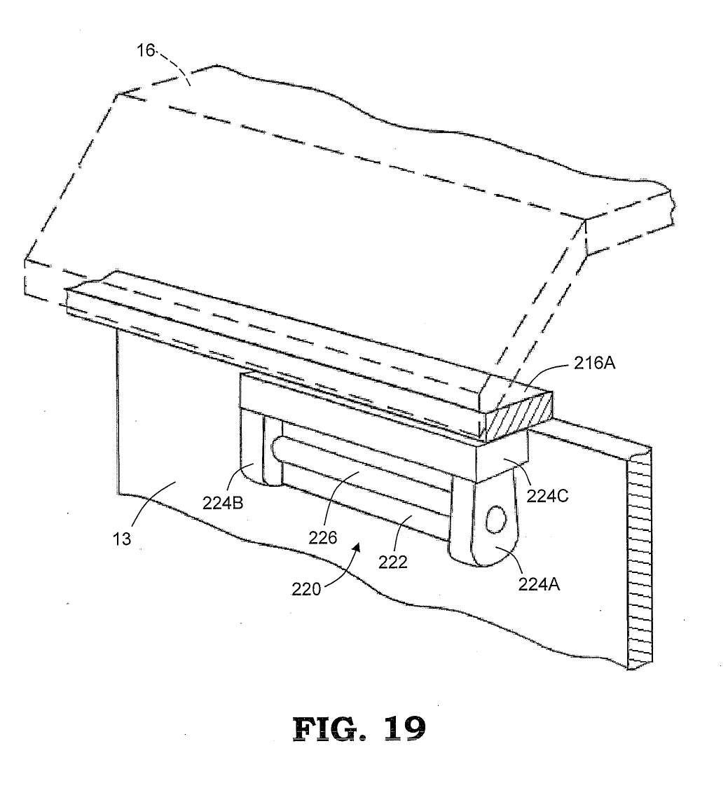

Referring now to FIGS. 19 through 22, there is illustrated a third embodiment of a hinge assembly, indicated generally at 220. The hinge assembly 220 may include any structural features as described and illustrated above in the previous embodiments, although such is not required. Similar features have been numbered with common reference numerals but have been increased by 200 (e.g. 220, 222, 224, etc.). It should be appreciated that similar features are structured similarly, operate similarly, and/or have the same function unless otherwise indicated by the drawings or this specification.

For example, the hinge assembly 220 is configured to pivotally support the lid 16 on the rear wall 13 of the casket 10 as shown in FIG. 1. The illustrated hinge assembly 220 includes a first or base member 222 and a pair of second or pivotal members 224A and 224B. The illustrated base member 222 is secured to the rear wall 13 of the casket 10. The pivotal members 224A and 22B are movably supported on the base member 222 by a dowel pin 226 or the like. In turn, the lid 16 is secured to the pivotal members 224A and 224B, as will be explained below.

The base member 222 can be secured to the rear wall 13 of the casket 10 using a natural adhesive, a dovetail connection, wooden pegs, or any other type of connection. The illustrated base member 222 includes a U-shaped channel that is formed in an outwardly facing surface thereof and extends generally parallel with an upper edge of the rear wall 13, the purpose of which will be explained below. The base member 222 may, however, have any desired shape or structural features.

The illustrated pivotal members 224A and 224B are secured to a cross member 224C using a natural adhesive, dovetail connections, wooden pegs, or any other types of connections. Alternatively, the pivotal members 224A and 224B and the cross member 224C may be formed as a single component. The illustrated pivotal members 224A and 224B define a pair of holes that are coaxially aligned with one another, the purpose of which will be explained below.

In turn, the illustrated lid 16 is secured to the cross member 224C. For example, the lid 16 includes a base ledge 216A that extends around an inner periphery thereof, although such is not required. The base ledge 216A can provide support to the lid 16 and facilitates mounting of the lid 16 to the hinge assembly 220. The base ledge 216A of the lid 16 is secured to a top surface of the cross member 224C using a natural adhesive, a dovetail connection, wooden pegs, or any other type of connection.

The dowel pin 226 is secured in the U-shaped channel of the base member 222 using, for example, a natural adhesive or any other type of connection. Opposite ends of the dowel pin 226 extend from opposite sides of the base member 222. The ends of the dowel pin 226 are respectively received within the holes of the pivotal members 224A and 224B such that the pivotal members 224A and 224B are pivotally supported adjacent to the opposite sides of the base member 222. As a result, the lid 16 is pivotally supported on the rear wall 13 of the casket 10.

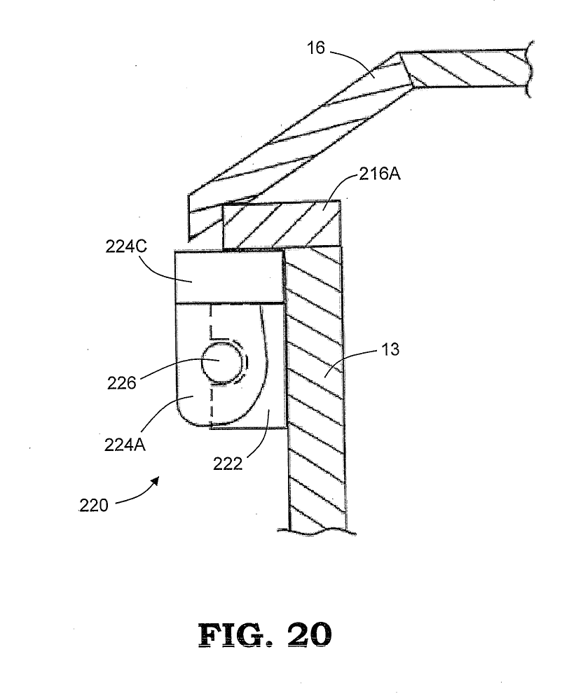

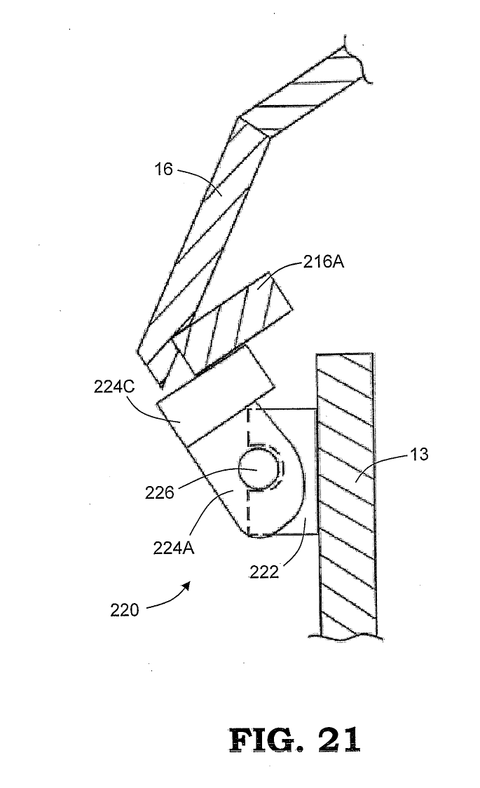

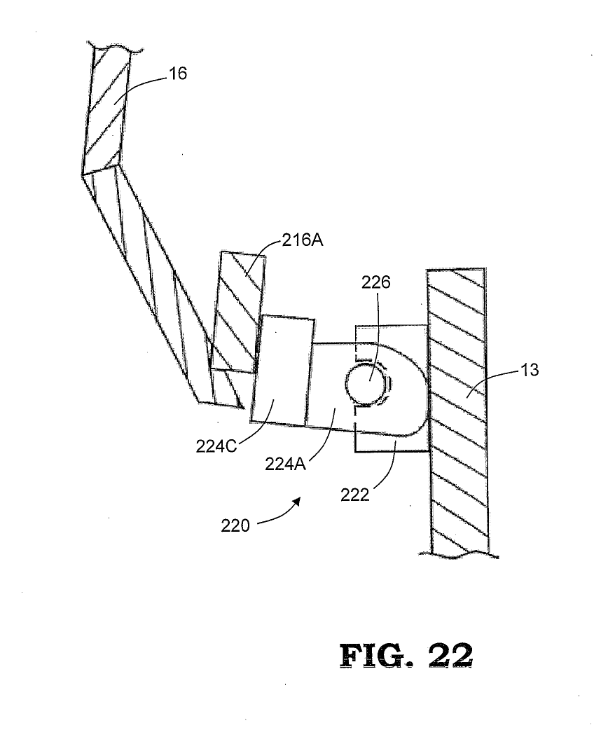

As shown in FIG. 20, the lid 16 of the casket 10 is initially in the closed position. In the closed position, the lid 16 extends over the rear wall 13 and conceals an internal portion of the casket 10. The lid 16 can be moved from the closed position to a partially opened position, which is shown in FIG. 21, and further to the opened position, which is shown in FIG. 22. The lid 16 reaches the fully opened position when a bottom edge of the pivotal members 224A and 224B come into contact with an outer surface of the rear wall 13 of the casket 10, thereby preventing the lid 16 from pivoting beyond the fully opened position.

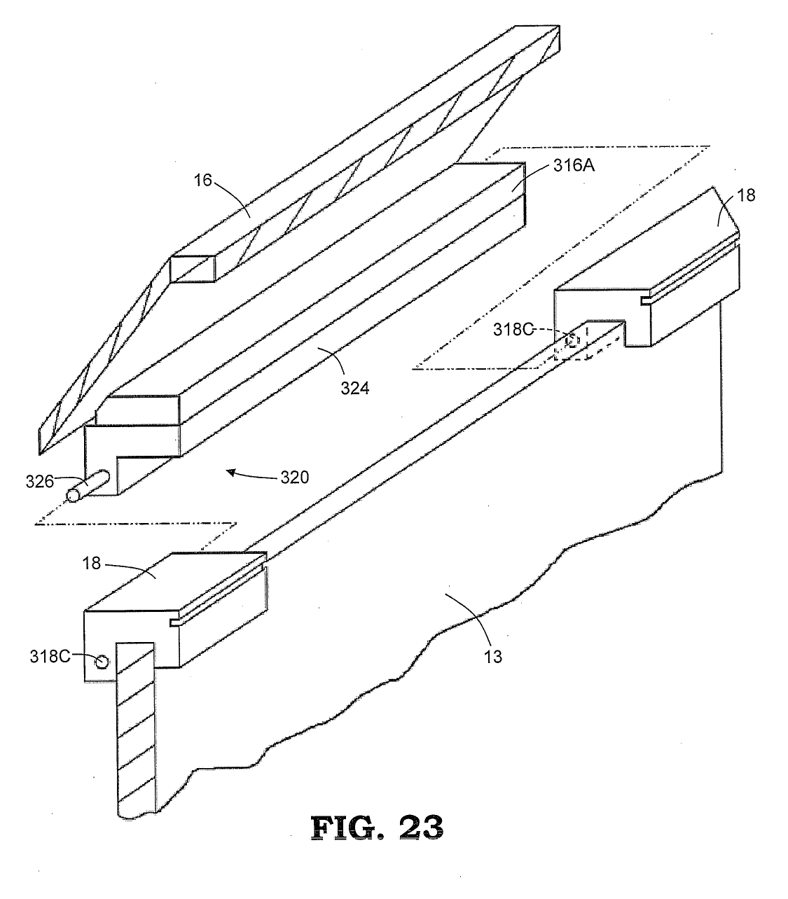

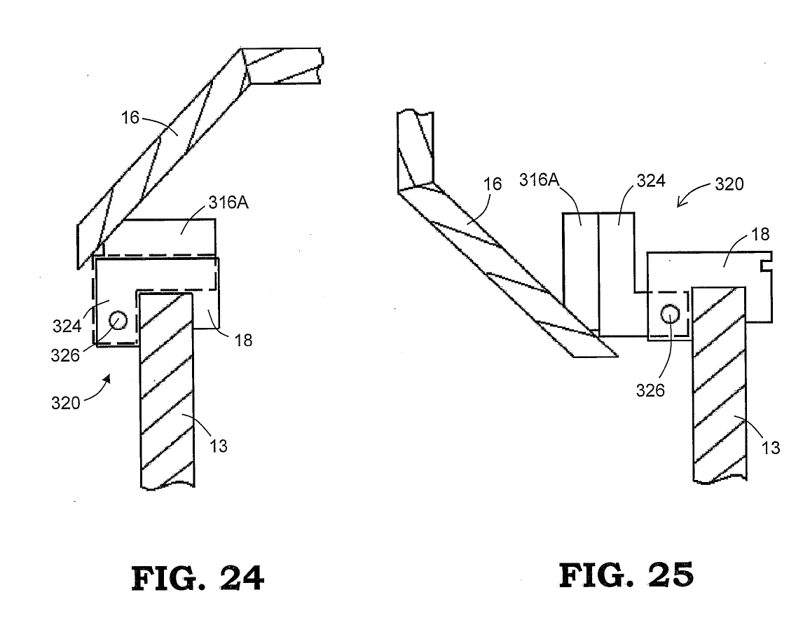

Referring now to FIGS. 23 through 25, there is illustrated a fourth embodiment of a hinge assembly, indicated generally at 320. The hinge assembly 320 may include any structural features as described and illustrated above in the previous embodiments, although such is not required. Similar features have been numbered with common reference numerals but have been increased by 300 (e.g. 320, 322, etc.). It should be appreciated that similar features are structured similarly, operate similarly, and/or have the same function unless otherwise indicated by the drawings or this specification.

For example, the hinge assembly 320 is configured to pivotally support the lid 16 on the rear wall 13 of the casket 10 as shown in FIG. 1. The illustrated hinge assembly 320 includes a first or pivotal member 324 that is integrated with the cap 18 of the casket 10. As shown, the pivotal member 324 has a cross-sectional shape the generally corresponds with a cross-sectional shape of the cap 18, although such is not required.

The pivotal member 324 includes a pair of dowel pins 326 that extends from opposite sides thereof, although only one dowel pin 326 is shown in FIG. 23. The illustrated dowel pins 326 can be inserted into holes (not shown) that are formed in opposite sides of the pivotal member 324. The dowel pins 326 can be secured therein by a natural adhesive or a threaded connection, for example. The dowel pins 326 are coaxially aligned with one another along a length of the pivotal member 324 thereby forming an axis or rotation for the lid 16, as will become apparent.

The pivotal member 324 is supported between a first section and a second section of the cap 18. The illustrated first and second sections of the cap 18 define a pair of coaxially aligned holes 318C formed in opposing sides thereof. The ends of the dowel pins 326 on the pivotal member 324 are inserted into the holes 318C. The dowel pins 326, which are secured to the pivotal member 324, can move freely within the holes 318C formed in the cap 18. Thus, the pivotal member 324 can pivot freely relative to the cap 18 and rear wall 13 of the casket 10. Further, when the pivotal member 324 is supported on the cap 18, the pivotal member 324 appears to be an integral part of the cap 18 and hidden from view.

In turn, the illustrated lid 16 is secured to the pivotal member 324. For example, the lid 16 includes a base ledge 316A that extends around an inner periphery thereof, although such is not required. The base ledge 316A can provide support to the lid 16 and facilitate mounting of the lid 16 to the hinge assembly 320. The base ledge 316A of the lid 16 is then secured to a top surface of the pivotal member 324. The base ledge 316A can be secured to the pivotal member 324 using a natural adhesive, a dovetail connection, wooden pegs, or any other type of connection. Thus, the hinge assembly 320 supports the lid 16 on the rear wall 13 of the casket 10 for movement between the closed position and the opened position.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A casket comprising:
a box having a bottom and a plurality of side walls, wherein the box is made from naturally occurring materials;
a hinge assembly including a first member secured to a side wall of the box and a second member pivotally supported on the first member by a dowel pin, wherein the hinge assembly is made from naturally occurring materials; and
a lid secured to the second member of the hinge assembly for pivotal movement between a closed position and an opened position, wherein the lid is made from naturally occurring materials.

2. The casket of claim 1 further including a support arm that is provided between the lid and a side wall of the box for securing the lid in the opened position.

3. The casket of claim 2, wherein the support arm is pivotally supported on the lid for movement between a locked position and an unlocked position relative to the side wall.

4. The casket of claim 3, wherein the support arm includes an L-shaped slot that extends along a portion thereof.

5. The casket of claim 4 further including a guide pin that is secured to an inner surface of the respective side wall of the box, and the guide pin is received within the slot of the support arm.

6. The casket of claim 1, wherein the hinge assembly further includes a securing member that is pivotally supported on one of the first and second members for securing the lid in the opened position.

7. The casket of claim 6, wherein the securing member is pivotally supported on the second member and adapted to contact the first member to secure the lid in the opened position.

8. The casket of claim 7, wherein the securing member and the first member have corresponding edges that automatically engage one another when the lid is in the opened position.

9. The casket of claim 6, wherein the securing member includes a knob to facilitate pivotal movement of the securing member between a locked position and an unlocked position.

10. The casket of claim 1, wherein the second member of the hinge assembly includes a pair of pivotal members that are pivotally supported on opposite ends of the dowel pin.

11. The casket of claim 10, wherein the pivotal members define a pair of coaxially aligned apertures that respectively receive opposite ends of the dowel pin.

12. The casket of claim 11, wherein the first member of the hinge assembly defines a U-shaped channel that receives the dowel pin.

13. The casket of claim 1, wherein the first member of the hinge assembly forms a cap that extends along an upper edge of at least one of the side walls of the box, and the second member of the hinge assembly is pivotally supported on the cap.

14. The casket of claim 13, wherein the second member of the hinge assembly is pivotally supported between first and second sections of the cap.

15. The casket of claim 14, wherein the second member is pivotally supported between first and second sections of the cap by a pair of dowel pins that extend from opposite ends of the second member.

16. The casket of claim 15, wherein the second member of the hinge assembly has a cross-sectional shape that generally corresponds with a cross-sectional shape of the cap.
